(19) United States
(12) Patent Application Publication
(10) Pub. No.: US 2025/0282564 A1
(43) Pub. Date: Sep. 11, 2025

(54) TRANSPORT SYSTEM

(71) Applicant: WEISS GMBH, Buchen (Odw.) (DE)

(72) Inventor: Martin GÖTZINGER, Buchen (DE)

(21) Appl. No.: 19/058,116

(22) Filed: Feb. 20, 2025

(30) Foreign Application Priority Data
Mar. 5, 2024 (DE) 102024106295.9

(51) Int. Cl. B65G 54/02

(52) U.S. Cl. CPC B65G 54/02

(57) ABSTRACT

A transport system for transporting objects, said transport system including a transport rail, which has at least a first running surface and a second running surface that are arranged disposed opposite one another. A transport trolley includes a base body that is coupled to an object carrier for an object to be transported. A first roller and a second roller are arranged at the base body and cooperate with the first running surface. A third roller is arranged at an extension arm that has a base section connected to the base body, and the third roller is arranged at an end section and wherein a solid-state joint has a lower flexural rigidity than the base section and/or the end section at least in a transport direction. The extension arm being arranged such that the third roller is pressed against the second running surface with a preload.

### CROSS-REFERENCES TO RELATED APPLICATIONS

This application claims the benefit of German Application No. 102024106295.9, filed Mar. 5, 2024. The entire disclosure of the application referenced above is incorporated herein by reference.

The invention relates to a transport system for transporting objects.

Transport trolleys and corresponding transport systems are, for example, used in automation technology to transport objects from one location to another location, for example, from one production step to the next. For this purpose, the objects are positioned on transport trolleys and the transport trolleys are traveled along a rail. The rail can in this respect have straight and/or curved sections.

In practice, value is in particular placed on the cornering ability of the system since systems that are not capable of cornering work discontinuously and their clock rates are limited. Furthermore, the rail systems should simultaneously have a high load-bearing capability and a good profile accuracy to be able to both transport high loads and ensure a high accuracy in the positioning of the transport trolleys and a low noise development during transport.

It is furthermore of essential importance that the transport trolleys or the transport systems work reliably and are nevertheless inexpensive in the manufacture and the assembly.

It is therefore an object of the invention to provide a transport system that satisfies all of the above-mentioned requirements.

This object is satisfied by a transport system in accordance with claim 1.

A transport system according to the invention comprises at least one transport rail, which has at least a first running surface and a second running surface that are arranged disposed opposite one another, and at least one transport trolley. The transport trolley comprises a base body having a coupling surface that is coupled or can be coupled to an object carrier for receiving at least one object to be transported. The object carrier can also be formed integrally with the base body.

A plurality of transport trolleys are usually provided that are preferably individually controllable so that they can be moved independently of one another along the transport rail.

The transport trolley comprises at least a first roller rotatably supported about a first axis of rotation and at least a second roller rotatably supported about a second axis of rotation. The first and the second roller are arranged at the base body such that the first and the second axis of rotation are stationary relative to the base body and such that said first and second roller cooperate with the first running surface. The first and the second axis of rotation define an axial direction that is perpendicular to a transport direction of the transport trolley. It is conceivable that further stationary rollers are provided.

The transport trolley furthermore comprises at least a third roller that is rotatably supported about a third axis of rotation and that is arranged at an extension arm that has a base section connected to the base body, an elastically acting solid-state joint adjoining the base section, and an end section adjoining the solid-state joint. The third roller is arranged at the end section.

The solid-state joint has a lower flexural rigidity than the base section and/or the end section at least in the transport direction. The lower flexural rigidity is such that the solid-state joint can be elastically deformed more easily in the transport direction than the base section and/or the end section. Or, in other words: The solid-state joint is more easily bendable than the base section and/or the end section to enable an outward pivoting of the end section on an external exertion of force. In this respect, the force usually acts on the third roller so that it moves away from the other rollers.

The extension arm, in particular the solid-state joint, is designed and arranged such that the third roller is pressed against the second running surface with a preload.

Further rollers can be present that are arranged at an extension arm of the above-described kind. A plurality of extension arms can generally also be provided. Two or more rollers, but preferably exactly one, can be associated with an extension arm.

The number of stationary rollers (but at least 2) and the number of rollers arranged at an extension arm can generally be selected as required, for example, to be able to reliably absorb the loads occurring during operation of the system.

In many systems, the width of the transport rail varies in its course. A change in the rail width can in particular occur in a transition from a straight transport section to a curved section having a constant radius. In this transition, the transport rail has a course that is described by one or more functions (e.g. polynomials) that are calculated as part of complex optimization processes. The two sides of the rail can be described by different functions so that their course is not necessarily parallel.

Due to the support of the third roller at the extension arm, a spacing between the third roller, on the one hand, and the first and the second roller, on the other hand, is variable, whereas the spacing between the first and the second roller is constant. Due to the non-stationary support of the third roller, the variations in the rail width and/or tolerances can be reliably absorbed. It is ensured by the preload that the third roller is always pressed against the rail with a sufficiently large force. Ultimately, this has the result that the first and second roller also have reliable contact with the transport rail. In this respect, it is endeavored that no slippage occurs between the rollers and the transport rail.

In other words, the extension arm acts like a kind of preloaded spring that is elastically deformable in the region of the solid-state joint, in particular only in the region of the solid-state joint. The customer interface in the form of the object carrier is decoupled from the movement/deformation of the extension arm in this respect.

The movable support of the third roller at the extension arm with a solid-state joint, for example, has the advantage over a support at a pivot arm that no additional movable parts such as hinges, spring elements or the like are required. The extension arm according to the invention is therefore characterized by a reduced complexity so that it is comparatively easy to manufacture and economical. In particular, there is virtually no wear in the solid-state joint and the risk of malfunctions is significantly reduced, which makes the extension arm particularly robust and easy to maintain.

The term running surface is to be understood broadly in the context of the present invention. In addition to planar surfaces, it also includes surfaces with a more complex geometry. Such running surfaces can comprise part surfaces that are inclined with respect to one another, such as running surfaces having a wedge shape in a cross-section.

Further embodiments of the invention are set forth in the claims, in the description, and in the enclosed drawings.

According to one embodiment, the solid-state joint has a first flexural rigidity in the transport direction and a second flexural rigidity in the axial direction, wherein the first flexural rigidity is less than the second flexural rigidity. This means that, in the event of a force application, the solid-state joint can—precisely in response to this force application—be bent more easily in the transport direction than in the event of a force application to the joint in the axial direction, wherein a transverse direction, which is perpendicular to the transport direction and perpendicular to the axial direction, in this respect represents the bending axis in each case.

The second flexural rigidity may be more than 300%, preferably more than 400%, in particular more than 500%, greater than the first flexural rigidity.

According to one embodiment, the solid-state joint has a first spring rate in the axial direction and a second spring rate in the transport direction, wherein the first spring rate is greater than the second spring rate. The first and second spring rates can be measured at an introduced force of 100 N at the end of the solid-state joint near the end section. The first spring rate can be more than 150%, in particular more than 250%, in particular more than 500% of the second spring rate.

According to one embodiment, a force application or force introduction to the third roller in a transverse direction, which is perpendicular to the transport direction and perpendicular to the axial direction, results in a first deflection of the third roller in the transverse direction and in a second deflection of the third roller in the axial direction, wherein the first deflection is greater than the second deflection. The first deflection can be more than 250%, in particular more than 500%, in particular more than 750%, in particular more than 1000%, in particular more than 1500% of the second deflection.

One example: It is assumed that the first spring rate is approximately 10500 N/mm and the second spring rate is approximately 6900 N/mm. With an introduced force of 100 N on the third roller in the transverse direction, the first deflection is 34 μm and the second deflection is 7 μm. In other words, on a force application to the third roller in the transverse direction that, for example, results from an irregular rail width, the extension arm can be deflected more than 4 times less in the axial direction than in the transverse direction. This means that the extension arm can be configured to enable a deflection of the third roller with respect to the base body in a direction perpendicular to the axial direction and to substantially prevent a tilting of the third roller relative to the axial direction, even though the force (in particular the preload force of the third roller) is applied below the extension arm. The tilt can be less than 0.01°.

The numerical values specified in the example have tolerances of +/−10%. It is understood that the flexural rigidities or spring rates can be adapted to the respective present conditions as required.

One embodiment provides that the end section extends substantially parallel to the transport direction.

According to one embodiment, the solid-state joint extends substantially in a direction perpendicular to the transport direction and perpendicular to the axial direction. In other words, the longitudinal axes of the solid-state joint and the end section can substantially form a right angle.

According to one embodiment, the base section is arranged laterally offset with respect to the third roller in a direction perpendicular to the transport direction and perpendicular to the axial direction.

According to one embodiment, the base section has a width in the transport direction and a thickness in the axial direction, the solid-state joint has a width in the transport direction and a thickness in the axial direction and the end section has a width in a direction perpendicular to the axial direction and to the transport direction and has a thickness in the axial direction, wherein the solid-state joint at least sectionally has a smaller width and/or thickness than the base section and/or the end section. In other words, the solid-state joint is at least sectionally narrower and/or thinner than the base section and/or the end section. The width of the solid-state joint can, for example, be less than 90%, in particular less than 80%, in particular less than 70%, in particular less than 50% of the width of the base section and/or the end section. The thickness of the solid-state joint can, for example, be less than 90%, in particular less than 80%, in particular less than 70% of the thickness of the base section and/or the end section. However, the solid-state joint can also have the same thickness as the base section and/or the end section.

According to one embodiment, the solid-state joint comprises two side surfaces, wherein at least one, preferably both, of the side surfaces is inclined with respect to the axial direction. The solid-state joint can in particular at least sectionally have the shape of an inclined parallelogram in a cross-section in a plane that is spanned by the transport direction and the axial direction. An angle of inclination of the side surface with respect to the axial direction can, for example, be between 45° and 5°, in particular between 40° and 20°, in particular between 35° and 15°, in particular between 30° and 20°. All three axes of rotation are thereby kept substantially parallel on a deflection of the third roller in the transverse direction.

According to one embodiment, at least the solid-state joint has at least one recess. Said recess is preferably formed at a side surface of the solid-state joint, wherein the recess extends at least sectionally, preferably completely, along the side surface. Each side surface can in particular have two parallel recesses that are spaced apart from one another and that each extend completely along the respective side surface. For example, oppositely disposed recesses can be formed on both side surfaces so that at least one constriction is formed. Two constrictions are preferably formed.

According to one embodiment, the extension arm has an articulation surface facing the object. The sections of the extension arm preferably have a common articulation surface facing the object. The articulation surface and the coupling surface are parallel planes or lie in the same plane. In particular, the articulation surface lies below the coupling surface in a position of use of the transport trolley, viewed in a direction perpendicular to the axial direction, i.e. the extension arm is offset with respect to the base body. In other words, viewed from the side, the surface of the extension arm lies lower than the coupling surface of the base body, whereby a cooperation between a mounted object and the extension arm can be avoided, in particular also on a deflection of the third roller.

One embodiment provides that the third axis of rotation is arranged laterally offset at the end section with respect to a center axis of the end section. This makes the transport trolley more compact and has a positive effect on the tilt resistance of the third roller.

According to one embodiment, the extension arm is formed in one piece. As a result, no additional mechanical parts are required for supporting the third roller, which reduces the complexity and thus the costs of the system. It is also possible for the solid-state joint to be formed in one piece with the base section or in one piece with the end section.

Alternatively or additionally, a two-piece or multi-piece design of the solid-state joint is conceivable.

According to one embodiment, the extension arm and the base body are formed in one piece, which makes the transport trolley particularly economical and robust. The extension arm and the base body can be produced by milling, for example. Alternatively, the extension arm and the base body can also be formed in multiple pieces. For example, an intermediate element can be provided that adjoins the base body and that connects the base body and the extension arm.

According to one embodiment, the axes of rotation of the rollers form an isosceles triangle, viewed in the axial direction, when the transport trolley is not located on the transport rail. A symmetrical yaw stiffness when moving the transport trolley along the transport rail is thereby achieved.

According to one embodiment, at least one carrier section extends from the base body in the axial direction and carries at least a fourth roller that is rotatably supported about a fourth axis of rotation. The fourth roller can be arranged at a free end of the carrier section. The fourth roller can have a smaller diameter than the first, the second and/or the third roller.

According to one embodiment, the fourth axis of rotation is arranged parallel to the first, the second and/or the third axis of rotation.

According to one embodiment, the transport system further comprises a third running surface that is formed at a support rail spaced apart from the transport rail, wherein the fourth roller is supported at the carrier section such that said fourth roller cooperates with the third running surface. A defined spacing between a runner unit of the transport trolley and a stator unit of the transport rail is thereby produced.

According to one embodiment, the transport rail is associated with a plurality of stator units that are arranged behind one another in the transport direction and that, together with a runner unit arranged at the at least one transport trolley, form a linear motor by means of which the at least one transport trolley can be moved along the transport rail, in particular wherein the runner unit is arranged at the carrier section, in particular wherein the runner unit is arranged between the base body and the fourth roller.

According to one embodiment, two extension arms extend from the base body and each have an end section having a third roller. The transport trolley can thereby be adapted for larger loads to be transported. The two solid-state joints of the two extension arms can be arranged parallel to one another and/or the two end sections of the two extension arms can be aligned. The two extension arms can each be configured in accordance with at least one of the above-described embodiments.

The present invention will be described by way of the example in the following with reference to advantageous embodiments and to the enclosed drawings. There are shown:

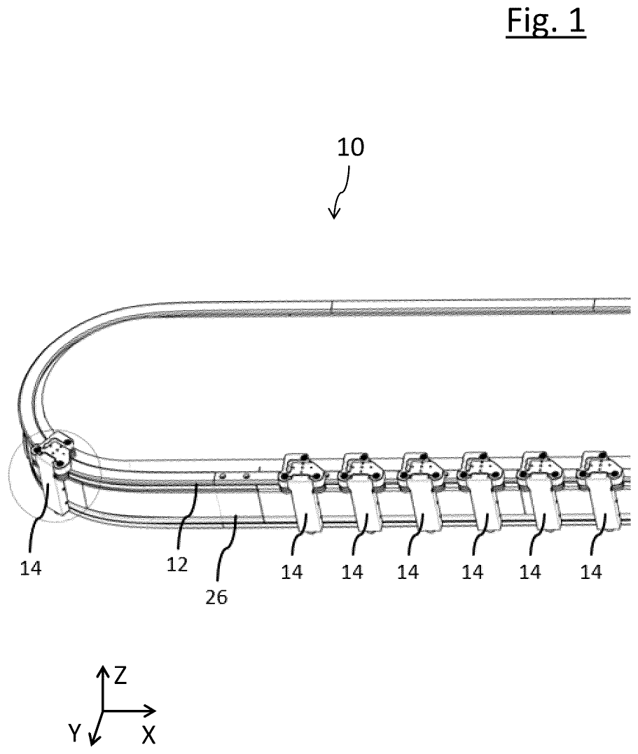

FIG. 1 a simplified, perspective view of a section of a transport system;

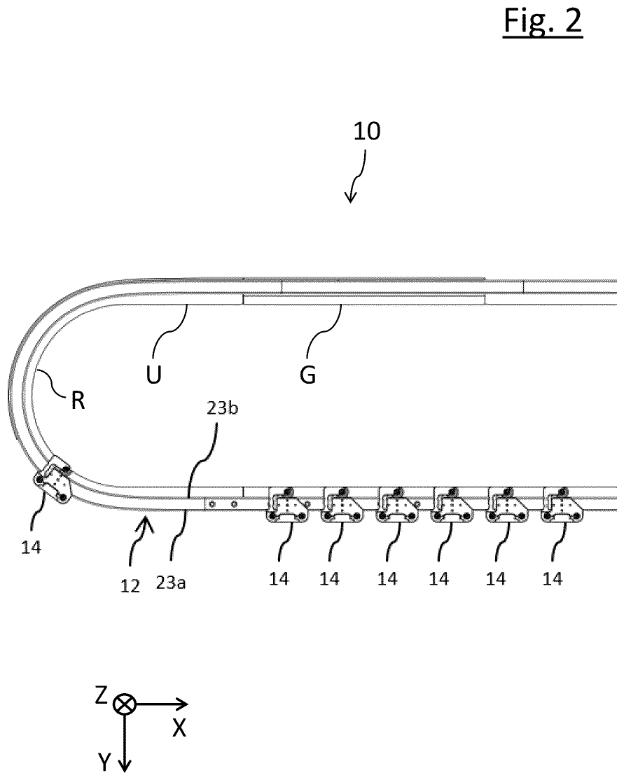

FIG. 2 a plan view of the transport system (simplified view);

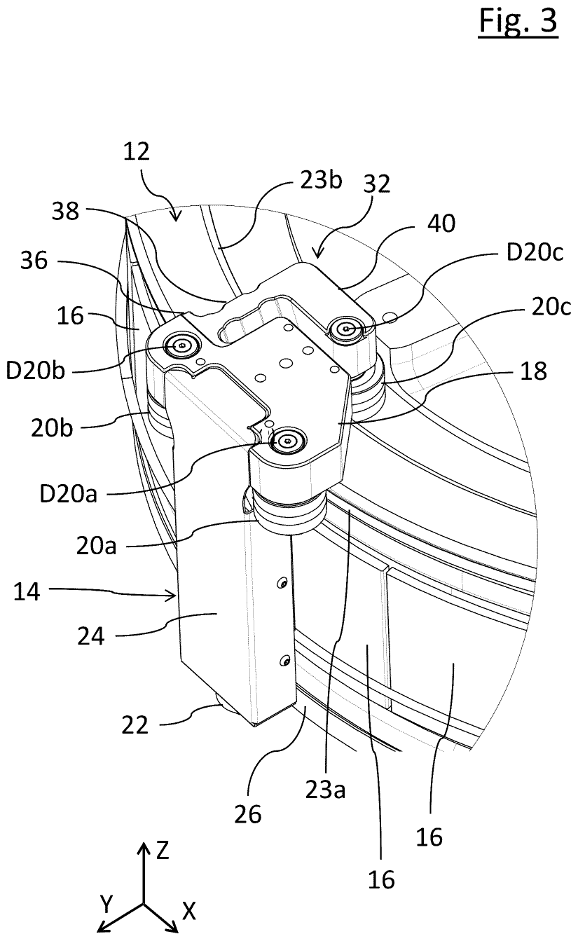

FIG. 3 a perspective view of a section of a transport system;

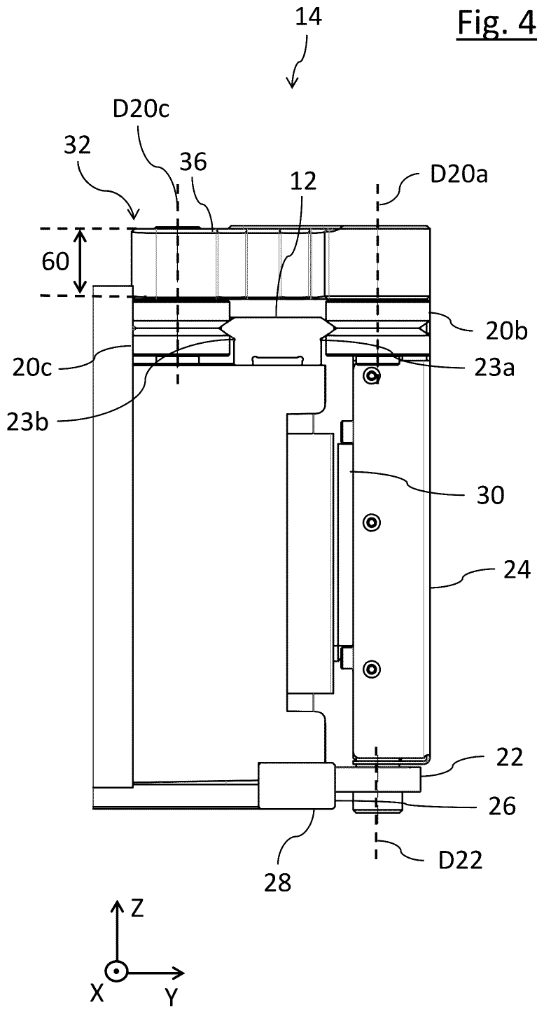

FIG. 4 a side view of a transport trolley;

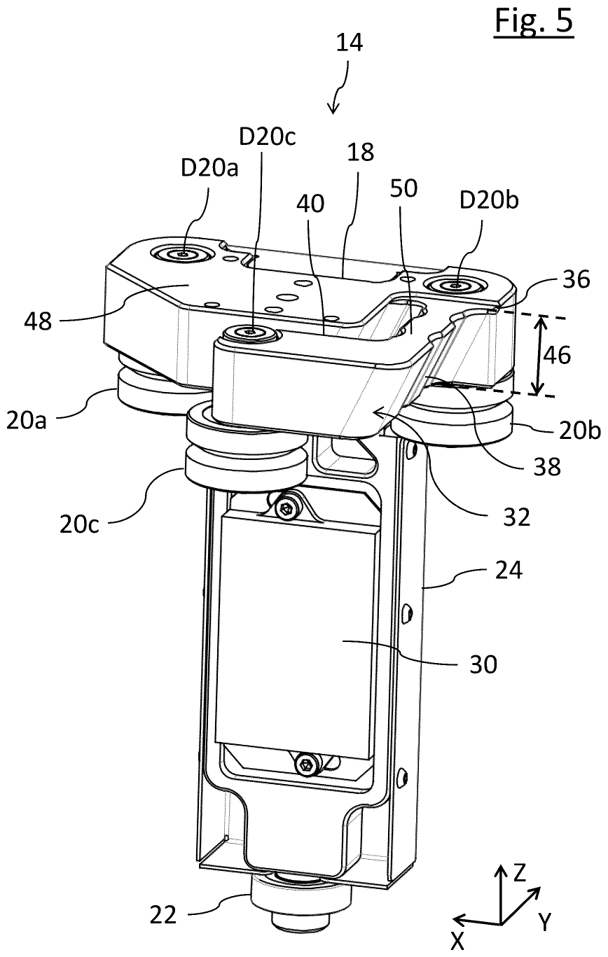

FIG. 5 a perspective view of the transport trolley of FIG. 4;

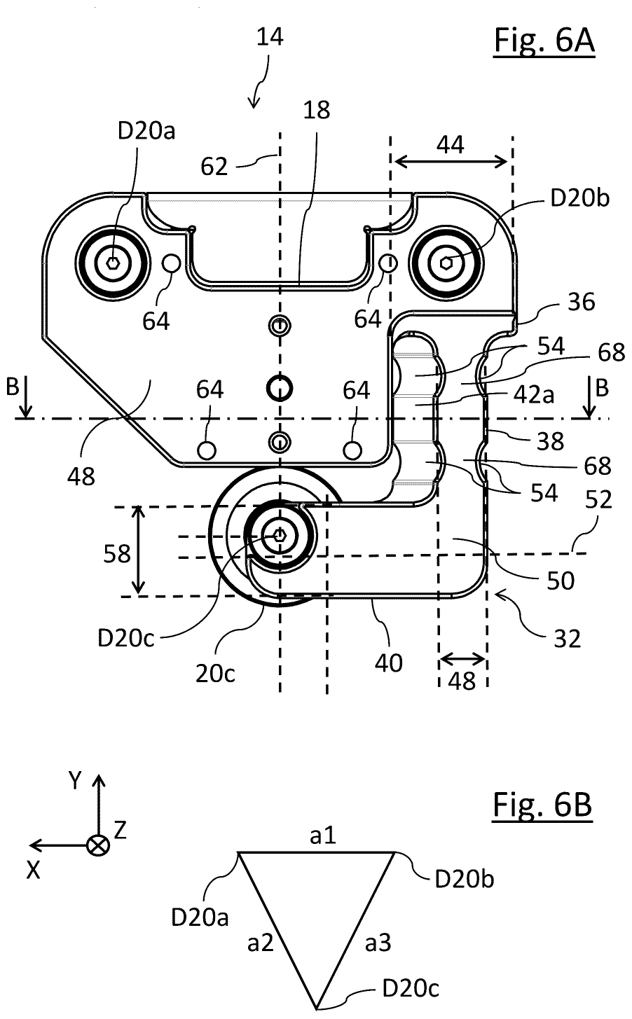

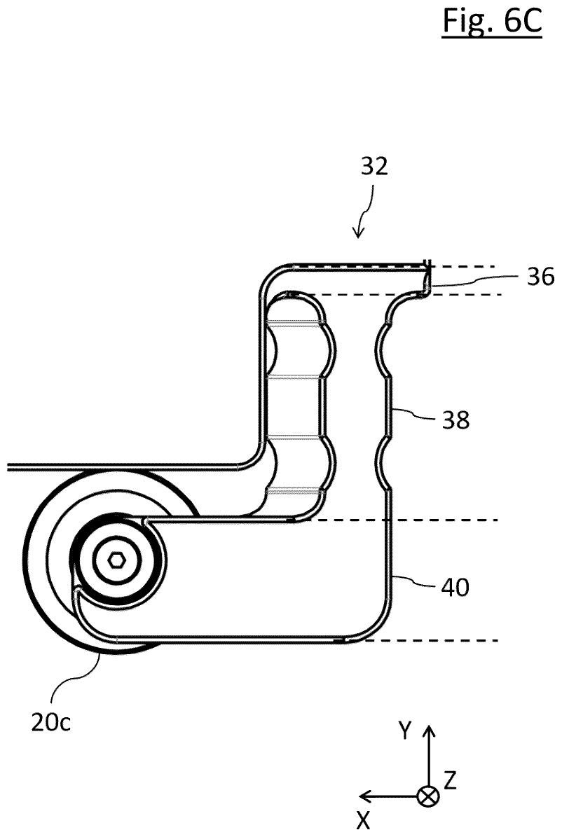

FIG. 6A a plan view of the transport trolley of FIG. 4;

FIG. 6B a schematic representation of the arrangement of the axes of rotation;

FIG. 6C a detailed view of the extension arm;

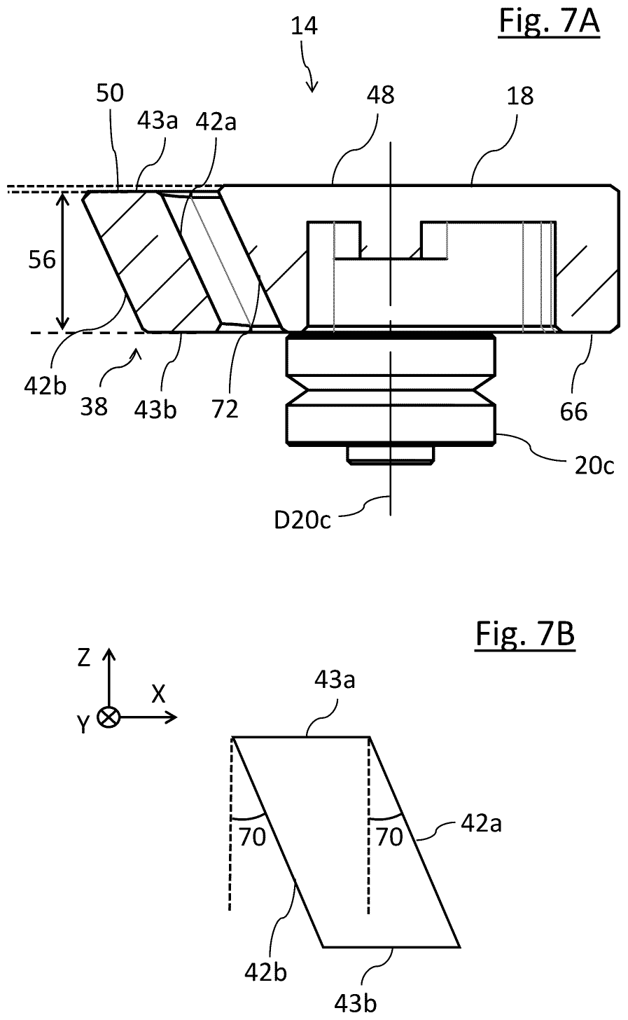

FIG. 7A a sectional view of the transport trolley along the line B-B drawn in FIG. 6A;

FIG. 7B a schematic representation of the cross-sectional shape of the solid-state joint;

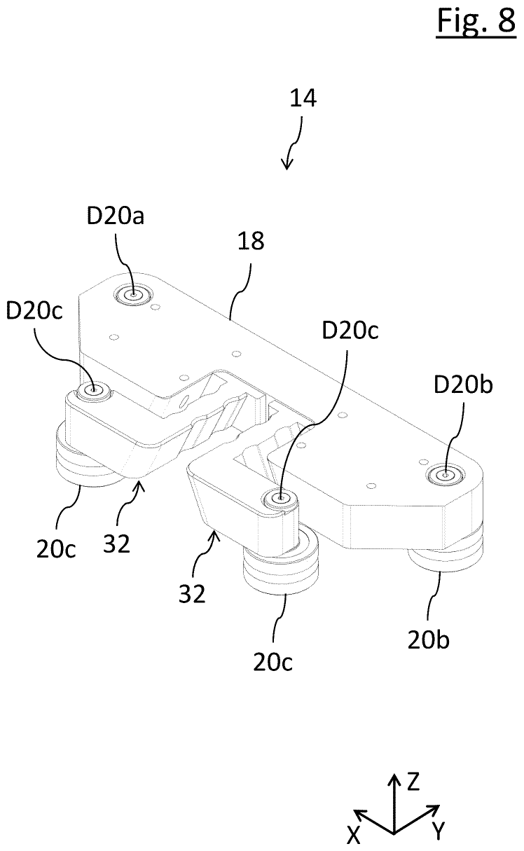

FIG. 8 a perspective view of a section of a transport trolley; and

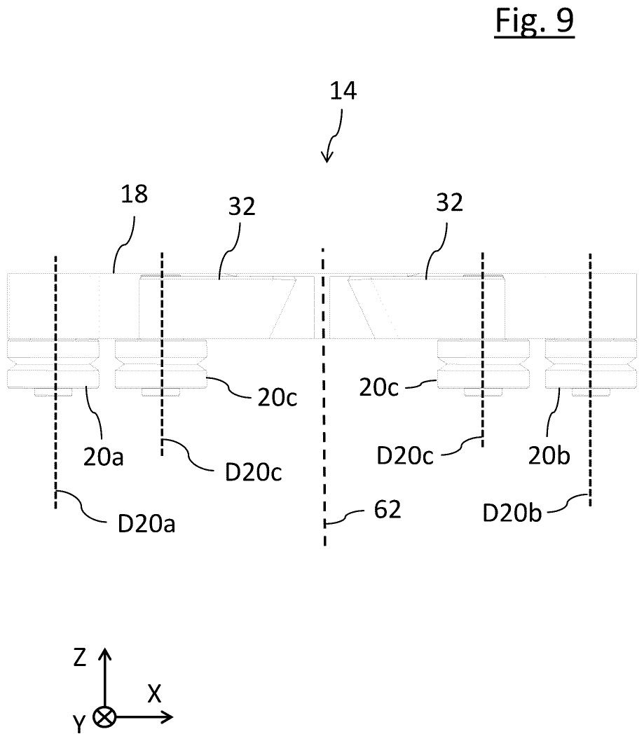

FIG. 9 a side view of the transport trolley of FIG. 8.

The transport system 10 shown in FIGS. 1 and 2 has a transport rail 12 having lateral running surfaces 23a, 23b along which one or more transport trolleys 14 can be moved in a transport direction X. For the sake of simplicity, the system 10 is only partly shown. Components not necessary for the understanding of the present invention have been omitted.

In the present embodiment example, the transport system 10 has sections G that have a straight transport path and that merge via transition sections U into curved sections R that have a constant radius of curvature. It is understood that, in deviation from the example shown, transport rails can be realized with any desired route.

Along the transport path defined by the transport rail 12, processing stations can, for example, be provided at which workpieces arranged on the transport trolley 14 can be processed. It is understood that the structure can be modular so that individual modules with certain lengths and/or certain radii of curvature can be easily combined with one another to obtain a transport system with the desired configuration.

FIG. 3 shows a perspective view of a section of the curved section R with a transport trolley 14. The driving of the transport trolley 14 takes place by a linear motor that has stator units 16 that are arranged behind one another in the longitudinal direction of the transport rail 12 and that cooperate with a runner unit 30 arranged at the transport trolley 14 (not visible, see FIGS. 4 and 5). The stator units 16 lie between the rails 12 and a support rail 28. The runner unit 30 can comprise a permanent magnet arrangement. By controlling the units 16 accordingly, magnetic fields are generated that are variable in the transport direction and over time and that drive the trolley 14 to move along the transport rail 12. Such linear motors are generally known.

The transport trolley 14 comprises a base body 18 at which a first roller 20a and a second roller 20b are supported. They are spatially fixed relative to the base body 18. The rollers 20a, 20b cooperate with the running surface 23a arranged at one side of the transport rail 12. As can be seen in the side view of FIG. 4, the running surface 23a has, in a cross-section, a wedge shape that engages into corresponding wedge grooves of the rollers 20a, 20b. The running surface 23b also has a wedge shape. Said wedge shape engages into a wedge groove of a further roller 20c that is associated with the oppositely disposed side of the transport rail 12 and that cooperates with the running surface 23b. The arrangement of the roller 20c will be described in more detail below with reference to FIGS. 4 and 7.

The above-described runner unit 30 of the transport trolley 14 is arranged at a carrier section 24 that extends downwardly in a perpendicular manner from the base body 18. Due to the forces occurring between the runner unit 30 and the stator units 16 during operation of the linear motor, tilting moments occur that act on the base body 18 and its guide at the transport rail 12. To absorb these tilting moments, a further roller 22 is provided at the free end of the carrier section 24 and cooperates with a running surface 26 of the support rail 28.

The axes of rotation D20a, D20b, D20c and D22 of the rollers 20a, 20b, 20c and 22 are arranged in parallel. The axes of rotation D20a, D20b, D20c and D22 in particular extend parallel to the axial direction Z. Furthermore, the axes of rotation D20a, D20b and D20c of the rollers 20a, 20b and 20c form an isosceles triangle, i.e. a spacing a1 between the axes of rotation D20a and D20b is equal to a spacing a2 between the axes of rotation D20a and D20c that, in turn, is equal to a spacing a3 between the axes of rotation D20b and D20c (see FIG. 6B, a1=a2=a3). This relationship applies in a state in which the transport trolley 14 is not mounted on the rail 12, i.e. the extension arm 32 is braced onto the rail 12 during the assembly of the transport trolley 14. For example, the preload is approximately 0.1 mm+/−10%.

The arrangement and design of the roller 22 can be selected as required. For example, it is additionally or alternatively possible to provide a roller 22 whose axis of rotation D22 is oriented perpendicular to those of the rollers 20a, 20b, 20c, for example, in order to absorb vertically acting forces. It is also conceivable to provide a plurality of rollers 22 having parallel or differently oriented axes of rotation.

FIG. 5 shows a perspective view of the transport trolley 14. In contrast to the rollers 20a, 20b, 20c, the roller 22 does not have a wedge groove in the present embodiment example. Accordingly, the running surface 26 of the support rail 28 is planar and not wedge-shaped (see FIG. 4).

In addition to the rollers 20a and 20b that are rotatably but spatially fixedly arranged at the base body 18, the base body 18 carries a further roller 20c that cooperates with the running surface 23b of the transport rail 12 that is disposed opposite the running surface 23a. Unlike the rollers 20a, 20b, however, the roller 20c is movable relative to the base body 18 since it is arranged at an extension arm 32 having an elastic solid-state joint 38. The roller 20c is arranged at the extension arm 32 such that it is pressed against the running surface 20c under a preload, i.e. the transport rail 12 is clamped between the roller 20c at the one side and the rollers 20a and 20b at the other side.

As can be clearly seen in FIG. 6A, the extension arm 32 has a base section 36 that adjoins the base body 18 (see also FIG. 6C). In the embodiment example shown, the base section 36 is arranged in the region of the second roller 20b, i.e. the base section 36 adjoins a section of the base body 18 at which the second roller 20b is arranged. Furthermore, the base section 26 is laterally offset in the transverse direction Y with respect to the third roller 20c. The transverse direction Y is to be understood as a direction that extends perpendicular to the transport direction X and perpendicular to the axial direction Z.

A solid-state joint 38 of the extension arm 32 extends in the transverse direction Y from the base section 36 to just above the base body 18 (see also FIG. 6C). The solid-state joint 38 has a first flexural rigidity in the transport direction X and a second flexural rigidity in the axial direction Z that is greater than the first flexural rigidity. The solid-state joint 38 can in particular be bent much less easily in the axial direction Z than in the transport direction X.

An end section 40 of the extension arm 32 extends in the transport direction X from the solid-state joint 38 to just above a center axis 62 of the base body 18 that extends parallel to the transverse direction Y. The roller 20c is arranged at a free end of the end section 40 (see also FIG. 6C). The axis of rotation D20c of the roller 20c is arranged laterally offset with respect to a center axis 52 of the end section 40 that extends parallel to the transport direction X. The axis of rotation D20c of the roller 20c furthermore lies on the center axis 62 of the base body 18, i.e. the roller 20c and the base body 18 are at the same height, viewed in the transport direction X. It is understood that the axis of rotation D20c does not have to lie on the center axis 62 of the base body 18 and does not have to be arranged laterally offset with respect to the center axis 52 of the end section 40 either if it serves to optimize the transport trolley for the respective present requirement profile.

According to a further embodiment, not shown, the base section 36 adjoins a section of the base body 18 at which the roller 20a is arranged. In this embodiment, the end section 40 extends in the opposite direction to the transport direction X from the solid-state joint 38.

The solid-state joint 38 is thinner than the base section 36 and the end section 40. In particular, a width 48 of the solid-state joint 38 in the transport direction X is smaller than a width 44 of the base section 36 in the transport direction X and smaller than a width 58 of the end section 40 in the transverse direction Y.

As can be seen in FIG. 4, 5 or 7A, the solid-state joint 38 is as thick as the base section 36 and the end section 40. A thickness 56 of the solid-state joint 38 is in particular equal to a thickness 46 of the base section 36 and equal to a thickness 60 of the end section 40. The respective thicknesses 56, 46, 60 refer to thicknesses in the axial direction Z. It is understood that the solid-state joint 38, the base section 36 and/or the end section 40 can, however, also have different thicknesses. For example, it is conceivable that the solid-state joint 38 is thinner than the base section 36 and/or the end section 40. However, a ratio between the width 48 of the solid-state joint 38 and the thickness 56 of the solid-state joint 38 is at least 1.5:1, preferably more than 2:1, particularly preferably more than 2.5:1, for example 2.65:1.

In the embodiment example shown, the extension arm 32 and the base body 18 are formed in one piece. The base body 18 and the extension arm 32 are, for example, milled out of the same workpiece, which is particularly economical. However, the base body 18 and the extension arm 32 can also be manufactured on the basis of a casting process. The base body 18 and the extension arm 32 are, for example, an aluminum cast part that can be reworked. This manufacturing method is also characterized by particularly low costs, and indeed without the technical properties of the transport trolley 14 being impaired in this respect.

However, it is also possible that the extension arm 32 is a separate component that is mounted at the base body 18, for example by means of a screw connection and/or welded connection.

In contrast to the embodiment example shown, the extension arm 32 can also consist of a plurality of interconnected components. For example, the solid-state joint 38 can be formed from a more flexible material than the base section 36 and the end section 40.

As can in particular be seen in FIG. 6A, the base body 18 comprises a coupling surface 48 that can be coupled to an object carrier for receiving at least one object to be transported. In the embodiment example shown, assembly holes 64 are provided in the coupling surface 48 and are configured to receive screws and/or grooves of the object carrier (see FIG. 6). However, other common fastening options are also conceivable, such as a tongue and groove connection or the like.

The extension arm 32 has an object-side articulation surface 50 that is offset in parallel from the coupling surface 48, viewed from the side, i.e. viewed in the transport direction X or the transverse direction Y, to ensure sufficient play between the extension arm 32 and the object carrier, in particular between the roller 20c deflectable in the transverse direction Y and the object carrier. However, it is also conceivable that the coupling surface 48 and the articulation surface 50 are substantially at the same axial height.

FIG. 7A shows a sectional view of a transport trolley 14 according to the invention along the line B-B drawn in FIG. 6A. As can be seen in FIG. 7A, the solid-state joint 38 comprises a side surface 42a, which is disposed opposite the base body 18 and is inclined with respect to the axial direction Z, and a side surface 42b that faces away from the base body 18 and that is likewise inclined with respect to the axial direction Z. The solid-state joint 38 furthermore comprises an upper side surface 43a, which represents a section of the articulation surface 50, and a lower side surface 43b. The upper side surface 43a and the lower side surface 43b lie in parallel planes that each extend perpendicular to the axial direction Z. The lower side surface 43b is aligned with a lower side 66 of the base body 18, while the upper side surface 43a lies lower than the coupling surface 48 of the base body 18, viewed from the side. The lower side 66 of the base body 18 is formed parallel to the coupling surface 48. It is understood that also only one of the side surfaces 42a, 42b can be inclined and that the lower side surface 43b does not have to be aligned with a lower side 66 of the base body 18.

As can in particular be seen in FIG. 7B, which schematically shows the cross-section of the solid-state joint 38, the solid-state joint 38 has the shape of an inclined parallelogram in a cross-section in a plane that is spanned by the transport direction X and the axial direction Z. In particular, a respective two parallel sides of the parallelogram, which are each associated with the surfaces 42a and 42b and the surfaces 43a and 43b, are of equal length.

The parallelogram is inclined in the direction of the base body 18. An angle of inclination 70 of the side surfaces 42a and 42b with respect to the axial direction Z can, for example, be between 45° and 5°, in particular between 40° and 10°, in particular between 35° and 15°, in particular between 30° and 20°. The base body 18 has a side surface 72 that is disposed opposite the solid-state joint 38 and that has the same angle of inclination 70 as the side surface 42a disposed opposite the base body 18 and/or the side surface 42b facing away from the base body 18 (see FIG. 7A).

Returning to FIG. 6A, each side surface 42a, 42b of the solid-state joint 38 has two parallel, mutually spaced apart recesses or grooves 54, wherein a respective two oppositely disposed recesses 54 form a constriction 68. Each recess 54 extends completely along the respective side surface 42a, 42b. It is understood that only one of the side surfaces 42a, 42b can also have one or two recesses 54. Alternatively, more than two, for example three, recesses 54 can also be provided in one or both side surfaces 42a, 42b. In addition, one recess 54 can also extend only sectionally along a side surface 42a, 42b. It is furthermore conceivable that the upper side surface 43a and/or the lower side surface 43b also has one or more recesses, for example at the position of the constrictions 68.

According to a further embodiment shown in FIGS. 8 and 9, two extension arms 32 extend from the base body 18 and each have an end section 40 having a roller 20c that cooperates with the running surface 23b. In this embodiment, the two end sections 40 of the two extension arms 32 are aligned and face in opposite directions (in particular along and opposite to the transport direction X) so that the two rollers 20c are arranged spaced apart from one another in the transport direction X. The two extension arms 32 can be configured as was described with respect to the embodiment in which only one extension arm 32 is provided.

The extension arm 32 according to the invention comprising an elastically deformable solid-state joint 38 has an optimized shape that, in interaction with the shape of the base body 18, enables a highly accurate positioning of the transport trolley 14 on the rail 12. In particular, due to the shape of the solid-state joint 38 (high rigidity in the axial direction Z), a tilting of the third roller 20c with respect to the base body 18 is almost completely prevented from taking place when moving the transport trolley 14 along the rail 12, whereas a deflection of the third roller 20c, in particular substantially only in the transverse direction Y, makes it possible to efficiently compensate production tolerances. Such production tolerances can, for example, represent unevenness on the rail surface or non-constant spacings between the running surfaces of the rail 12.

Furthermore, an excellent cornering ability of the transport trolley 14 is achieved by the deflection capability of the third roller 20c that is precisely defined due to the design of the solid-state joint 38.

At the same time, the preload force provided by the extension arm 32 ensures that, even when higher loads are to be transported, the transport trolley 14 is securely supported on the rail 12 and operates without slippage.

Furthermore, the extension arm 32 according to the invention is comparatively less complex and therefore particularly economical and robust. In this respect, the properties of the solid-state joint remain substantially constant over the life cycle of the transport trolley. Furthermore, the comparatively small number of separate moving parts also increases the positioning accuracy of the transport trolley 14.

One embodiment of the transport system with a linear motor (stator unit 16, runner units 30) was described above. However, it is understood that alternative drive concepts (e.g. belt drive, cam drive) can be provided. A combination of different drive concepts is also conceivable.

A transport system for transporting objects, said transport system comprising at least one transport rail, which has at least a first running surface and a second running surface that are arranged disposed opposite one another, and at least one transport trolley, said transport trolley comprising a base body having a coupling surface that is coupled or can be coupled to an object carrier for receiving at least one object to be transported; at least a first roller rotatably supported about a first axis of rotation and at least a second roller rotatably supported about a second axis of rotation, wherein the first and the second roller are arranged at the base body such that the first and the second axis of rotation are stationary relative to the base body and such that said first and second roller cooperate with the first running surface, wherein the first and the second axis of rotation define an axial direction that is perpendicular to a transport direction of the transport trolley; and at least a third roller that is rotatably supported about a third axis of rotation and that is arranged at an extension arm that has a base section connected to the base body, an elastically acting solid-state joint adjoining the base section, and an end section adjoining the solid-state joint, wherein the third roller is arranged at the end section and wherein the solid-state joint has a lower flexural rigidity than the base section and/or the end section at least in the transport direction, and wherein the extension arm, in particular the solid-state joint, is designed and arranged such that the third roller is pressed against the second running surface with a preload.

Reference numeral list:

| | |
|---|---|
| 10 | transport system |
| 12 | transport rail |
| 14 | transport trolley |
| 16 | stator unit |
| 18 | base body |
| 20a-20c, 22 | rollers |
| 23a, 23b, 26 | running surfaces |
| 24 | carrier section |
| 28 | support rail |
| 30 | runner unit |
| 32 | extension arm |
| 36 | base section |
| 38 | solid-state joint |
| 40 | end section |
| 42a, 42b | side surfaces of the solid-state joint |
| 43a, 43b | upper and lower side surface of the solid-state joint |
| 44 | width of the base section |
| 46 | thickness of the base section |
| 48 | coupling surface |
| 50 | articulation surface |
| 52 | center axis of the end section |
| 54 | recess |
| 56 | thickness of the solid-state joint |
| 58 | width of the end section |
| 60 | thickness of the end section |
| 62 | center axis of the base body |
| 64 | assembly holes |
| 66 | lower side of the base body |
| 68 | constriction |
| 70 | angle of inclination |
| 72 | inclined side surface of the base body |
| D20a-D20c, D22 | axes of rotation |
| X | transport direction |
| Y | transverse direction |
| Z | axial direction |

1. A transport system for transporting objects, said transport system comprising at least one transport rail, which has at least a first running surface and a second running surface that are arranged disposed opposite one another, and at least one transport trolley, said transport trolley comprising:
a base body having a coupling surface that is coupled or can be coupled to an object carrier for receiving at least one object to be transported;
at least a first roller rotatably supported about a first axis of rotation and at least a second roller rotatably supported about a second axis of rotation, wherein the first and the second roller are arranged at the base body such that the first and the second axis of rotation are stationary relative to the base body and such that said first and second roller cooperate with the first running surface, wherein the first and the second axis of rotation define an axial direction that is perpendicular to a transport direction of the transport trolley; and
at least a third roller that is rotatably supported about a third axis of rotation and that is arranged at an extension arm that has a base section connected to the base body, an elastically acting solid-state joint adjoining the base section, and an end section adjoining the solid-state joint, wherein the third roller is arranged at the end section,
wherein the solid-state joint has a lower flexural rigidity than the base section and/or the end section at least in the transport direction, and
wherein the extension arm is designed and arranged such that the third roller is pressed against the second running surface with a preload.

2. The transport system according to claim 1,
wherein the solid-state joint of the extension arm is designed and arranged such that the third roller is pressed against the second running surface with a preload.

3. The transport system according to claim 1,
wherein the solid-state joint has a first flexural rigidity in the transport direction and a second flexural rigidity in the axial direction, wherein the first flexural rigidity is less than the second flexural rigidity.

4. The transport system according to claim 3,
wherein the second flexural rigidity is more than 300% greater than the first flexural rigidity.

5. The transport system according to claim 1,
wherein the end section extends substantially parallel to the transport direction.

6. The transport system according to claim 1,
wherein the solid-state joint extends substantially parallel to a transverse direction that is perpendicular to the transport direction and perpendicular to the axial direction.

7. The transport system according to claim 1,
wherein the base section is arranged laterally offset with respect to the third roller in a transverse direction perpendicular to the transport direction and perpendicular to the axial direction.

8. The transport system according to claim 1,
wherein the base section has a width in the transport direction and a thickness in the axial direction, wherein the solid-state joint has a width in the transport direction and a thickness in the axial direction, wherein the end section has a width in a transverse direction perpendicular to the axial direction and the transport direction and has a thickness in the axial direction,
wherein the solid-state joint at least sectionally has a smaller width and/or thickness than the base section and/or the end section.

9. The transport system according to claim 1,
wherein the solid-state joint comprises two side surfaces, wherein at least one of the side surfaces is inclined with respect to the axial direction.

10. The transport system according to claim 9,
wherein both of the side surfaces is inclined with respect to the axial direction.

11. The transport system according to claim 9,
wherein the solid-state joint at least sectionally has the shape of an inclined parallelogram in a cross-section in a plane that is spanned by the transport direction and the axial direction.

12. The transport system according to claim 1,
wherein the solid-state joint has at least one recess, wherein the recess extends at least sectionally along the side surface.

13. The transport system according to claim 12,
wherein at least one side surface of the solid-state joint has said at least one recess.

14. The transport system according to claim 12,
wherein the recess extends completely along the side surface.

15. The transport system according to claim 12,
wherein each side surface has two parallel recesses that are spaced apart from one another and that each extend completely along the respective side surface.

16. The transport system according to claim 1,
wherein the extension arm has an articulation surface facing the object, wherein the articulation surface and the coupling surface are parallel planes or lie in the same plane.

17. The transport system according to claim 16,
wherein the sections of the extension arm have a common articulation surface facing the object.

18. The transport system according to claim 16,
wherein the articulation surface lies below the coupling surface in a position of use of the transport trolley, viewed in a direction perpendicular to the axial direction.

19. The transport system according to claim 1,
wherein the third axis of rotation is arranged laterally offset at the end section with respect to a center axis of the end section.

20. The transport system according to claim 1,
wherein the extension arm is formed in one piece.

21. The transport system according to claim 1,
wherein the extension arm and the base body are formed in one piece.

22. The transport system according to claim 1,
wherein the axes of rotation of the rollers form an isosceles triangle, viewed in the axial direction.

23. The transport system according to claim 1,
wherein at least one carrier section extends from the base body in the axial direction and carries at least a fourth roller that is rotatably supported about a fourth axis of rotation.

24. The transport system according to claim 23,
wherein the fourth roller is arranged at a free end of the carrier section.

25. The transport system according to claim 23,
wherein the fourth axis of rotation is arranged parallel to the first, the second and/or the third axis of rotation.

26. The transport system according to claim 23,
further comprising a third running surface that is formed at a support rail spaced apart from the transport rail, wherein the fourth roller is supported at the carrier section such that said fourth roller cooperates with the third running surface.

27. The transport system according to claim 1,
wherein the transport rail is associated with a plurality of stator units that are arranged behind one another in the transport direction and that, together with a runner unit arranged at the at least one transport trolley, form a linear motor by means of which the at least one transport trolley can be moved along the transport rail.

28. The transport system according to claim 27,
wherein the runner unit is arranged at the carrier section.

29. The transport system according to claim 28,
wherein the runner unit is arranged between the base body and the fourth roller.
